(19) United States
(12) Patent Application Publication
(10) Pub. No.: US 2010/0060742 A1
(43) Pub. Date: Mar. 11, 2010

(54) System for Providing Word-Information

(75) Inventors: Sang Woo Lee, Seoul (KR); Choung Suk Oh, Seoul (KR); Min Uk Kang, Seoul (KR)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignee: Unichal, Inc., Seoul (KR)

(21) Appl. No.: 12/524,745

(22) PCT Filed: Dec. 10, 2007
(86) PCT No.: PCT/KR07/06390

§ 371 Date: Jul. 28, 2009

(30) Foreign Application Priority Data
Apr. 20, 2007 (KR) 10-2007-0038793

(51) Int. Cl. H04N 5/225

(52) U.S. Cl. 348/207.1; 382/229; 348/333.02; 348/E05.024

(57) ABSTRACT

Disclosed is a word-information providing system that can form an image by photographing a printed matter recorded with words by a photographing device 100, and generate a word from the formed image by an information device 200, and transmit the generated word to a search device 300, and provide a proper information for the generated word by the search device 300. The word-information system can generate a word from the image formed by photographing words having a complicated language system, words that are normally used, or words that are not known to the user by the camera, and input the generated word into electronic dictionary or interne searching engine, there by allowing the user to search information for the word quickly and easily.

### TECHNICAL FIELD

The present invention relates to a word-information providing system, and more particularly, to a word-information providing system that can form an image by photographing a printed matter recorded with words by a photographing device, and generate a word from the formed image by an information device, and transmit the generated word to a search device, and provide a proper information for the generated word by the search device.

### BACKGROUND ART

FIG. 1 shows a conventional word input method and an information providing system related to the method. The system includes a client 10 capable of internet communication, and an information providing server 20 managing an integrated portal site.

In the system as described above, when a user inputs a word into the client using a keyboard generally, the information providing server 20 managing the integrated portal site provides a proper information for the word to the client, thereby allowing the user to obtain the information.

However, the conventional technology has a problem that it is very difficult to input and search words such as Chinese having a complicated language system or words, that cannot be learned by a dictionary because arrangement of the keyboard is different according to languages used by the user.

### DISCLOSURE OF THE INVENTION

### Technical Problem

Therefore, the present invention has been made to solve the above-mentioned problems occurring in the prior art, and an object of the present invention is to form an image by photographing a word to be searched by a photographing device, and transmit the image to an information device, and extract a word from the transmitted image, and obtain a proper information for the word by transmitting the extracted word to a search device.

Additional advantages, objects, and features of the invention will be set forth in part in the description which follows and in part will become apparent to those having ordinary skill in the art upon examination of the following or may be learned from practice of the invention.

### Technical Solution

According to an aspect of the present invention, there is provided a word-information providing system, which includes: a photographing device forming an image by photographing a printed matter recorded with words; an information device, receiving the formed image, converting the received image into an image whose characters can be easily recognized, generating a usable word from the converted image; and a search device searching and displaying a proper information for the generated usable word.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a construction view illustrating a conventional word-information providing system;

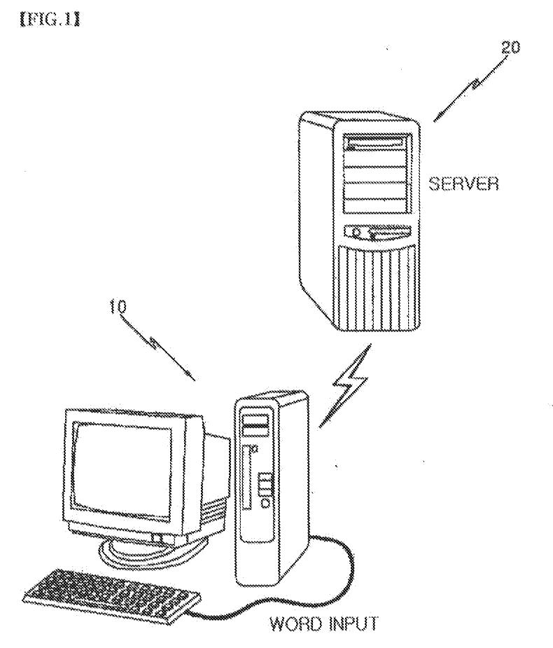

FIG. 2 is a construction view illustrating a word-information providing system according to the present invention; and

FIG. 3 is a block diagram illustrating an information device of the word-information providing system of FIG. 2.

### MODE FOR CARRYING OUT THE INVENTION

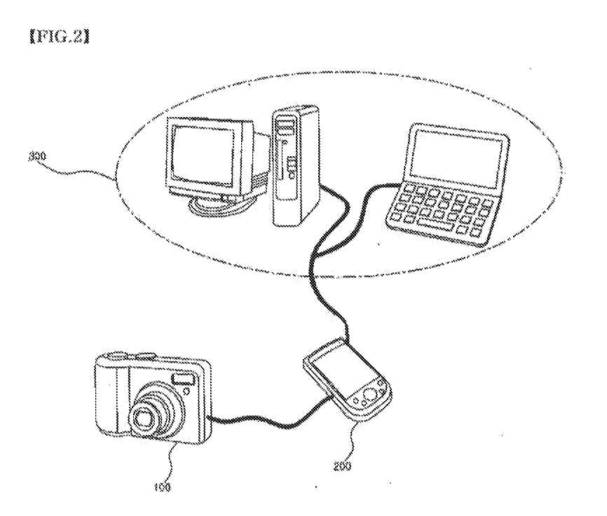

Referring to FIG. 2, a word-information providing system according to the present invention includes a photographing device 100, an information device 200 and a search device 300.

The word-information providing system provides a proper information for a usable word to a user. For example, in the case where there is appeared words such as a word that is unfamiliar but usable, a word having a different language system, a word that is not normally used, or a word that has been not learned, while the user reads a book, the word-information providing system forms an image by photographing the usable word using the photographing device 100 for obtaining information about the usable word, and generates a usable word recorded in the image by the information device 200, and extracts a proper information for the usable word by transmitting the usable word to the search device 300.

The photographing device 100 transmits the image formed by photographing the printed matter recorded with words to the word-recognition device 200. The photographing device 100 may be a camera or a digital camera provided in a mobile communication terminal.

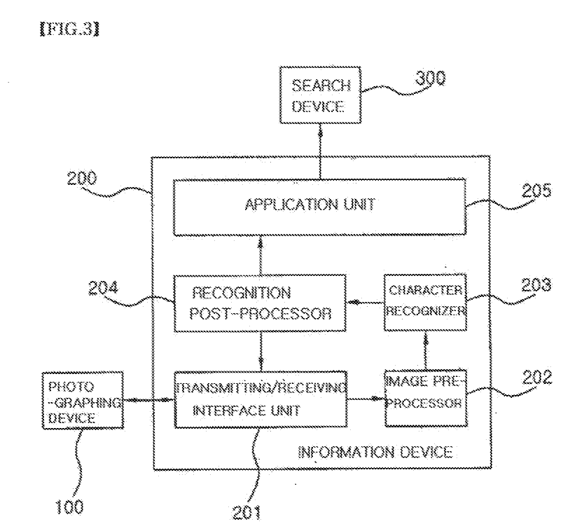

The information device 200 includes a transmitting/receiving interface unit 201, an image pre-processor 202, a character recognizer 203, a recognition post-processor 204 and an application unit 205 as shown in FIG. 3.

The transmitting/receiving interface unit 201 receives the image formed by photographing the printed matter recorded with words by the photographing device 100 through a communication unit such as USB (Universal Serial Bus), IrDA (Infrared Data Association), UART (Universal Asynchronous Receiver Transmitter), WUSB (Wireless Universal Serial Bus), Bluetooth and zigBee.

In addition, the transmitting/receiving interface unit 201 transmits a rephotographing instruction to the photographing device 100 when the recognition post-processor 204 determines that it is a word having one character, that is, meaningless word, thereby allowing the photographing device 100 to rephotograph the printed matter recorded with words.

In this time, a case where the word is determined to be meaningless in the recognition post-processor 204 will be explained in detain with the recognition post-processor 204 to be described below.

The image pre-processor 202 temporarily stores the image received from the transmitting/receiving interface unit 201, and converts the temporarily stored image into an image whose word can be easily recognized, and then transmits the converted image to the character recognizer 203.

Here, the received image is temporarily stored because it may take a time for the image pre-processor 202 to search a proper information for the usable word included in the image photographed by the photographing device 100 by using the search device 300, or it may take a time for the user to read the searched information.

The character recognizer 203 generates a word by using a well known word-recognition algorithm from the image that is converted to be easily recognizable of the word by the image pre-processor 202.

As described above, the character recognizer 203 sets a reference line, and determines the first word formed to the left or right about the reference line as a word to be searched by the user, and transmits only the first word to the recognition post-processor 204 because the formed word cannot exist more than two.

The recognition post-processor 204 determines whether the word generated by the character recognizer 203 is usable or meaningless.

For example, when the word that is unfamiliar but usable, in other words, a word having a different language system, a word that is not normally used, or a word that has been not learned, is photographed by the camera, words formed of one character such as ‘a’, ‘i’, ‘m’ are determined as the meaningless word if the words are generated from the image in the character recognizer 203 because the words are well known to the user normally.

As described above, it is desirable that the recognition post-processor 204 determines the meaningless word as a photographing error of the photographing device 100, and transmits a rephotographing instruction to the photographing device 100 through the transmitting/receiving interface unit 201 twice.

In this time, it is desirable that the photographing device 100 automatically rephotographs according to the rephotographing instruction, or the rephotographing instruction is displayed on a display of the photographing device 100, thereby allowing the user to rephotograph.

On the other hand, the unfamiliar usable word, in other words, the word having a different language system, the word that is not normally used, or the word that has been not learned, which are transmitted through the character recognizer 203 and not the word formed of one character. Thus, the recognition post-processor 204 transmits the unfamiliar usable word to the application unit 205.

The application unit 205 is cooperated with the search device 300, and transmits the usable word received from the recognition post-processor 204 to the cooperating search device 300.

When the information device 200 extracts the usable word from the image recorded with the word photographed by the photographing device 100, the search device 300 searches and displays a proper information for the extracted usable word.

The search device 300 receives the usable word from the application unit 205, and searches a proper meaning for the usable word.

The search device 300 may be an electronic dictionary. The electronic dictionary receives the usable word from the application unit 205, and extracts a proper information for the usable word, and provides the information to the user.

Or, the search device 300 may be a device provided with an internet searching engine. The device provided with the internet searching engine receives the usable word from the application unit 205, and searches a proper information for the usable word, and provides the information to the user.

### INDUSTRIAL APPLICABILITY

According to the present invention, the following effect is obtained.

The word-information system can generate the usable word from the image formed by photographing words having a complicated language system, words that are normally used, or words that are not known to the user by the camera, and input the generated usable word into electronic dictionary or internet searching engine, there by allowing the user to search information for the word quickly and easily.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

1. A word-information providing system, comprising:
a photographing device 100 forming an image
by photographing a printed matter recorded, with words;
an information device 200, receiving the formed image from the photographing device, converting the received image into an image whose characters can be easily recognized, generating a usable word from the converted image; and
a search device 300 searching and displaying a proper information for the generated usable word,
where the information device 200 comprises:
a transmitting/receiving interface unit 201 receiving the formed image from the photographing device 100;
an image pre-processor 202, temporarily storing the received image, converting the temporarily stored image into an image whose word can be easily recognized;
a character recognizer 203, setting a reference line to the image that is converted to be easily recognizable of the word by the image pre-processor 202, recognizing and generating the first word formed to the left or right from the reference line;
a recognition post-processor 204, receiving only the first word of the words generated by the character recognizer 203, determining whether the first word is a usable word to be searched by a user, transmitting a rephotographing instruction to the photographing device 100 through the transmitting/receiving interface unit 201 when receiving a word formed of one character, that is, a meaningless word; and
an application unit 205 extracting a proper information for the usable word by being cooperated with the search device 300.

2. The word-information providing system of claim 1, wherein the photographing device 100 rephotographs automatically according to the rephotographing instruction, or displays a message for rephotographing on a display thereof.

3. The word-information providing system of claim 1, wherein the search device 300 is an electronic dictionary or a device provided with an internet searching engine.
